(19) United States
(12) Patent Application Publication
(10) Pub. No.: US 2003/0051406 A1
(43) Pub. Date: Mar. 20, 2003

(54) Automatic mezzanine safety gate

(76) Inventors: Edward Ritz, Lebanon, CT (US); Roger Dargie, Poland, ME (US)

Correspondence Address: Barry L. Kelmachter, BACHMAN & LaPOINTE, P.C., Suite 1201, 900 Chapel Street, New Haven, CT, 06510-2802, US

(21) Appl. No.: 10/225,518

(22) Filed: Aug. 21, 2002

Related U.S. Application Data
(60) Provisional application No. 60/314,932, filed on Aug. 24, 2001.

(51) Int. Cl. E06B 3/68

(52) U.S. Cl. 49/50

(57) ABSTRACT

The present invention relates to an automatic safety gate for covering a gap or opening in a protective barrier installed on an upper floor or mezzanine. The automatic safety gate broadly includes a frame which defines an opening, a netting for closing the opening, and devices for raising and lowering the netting to move the netting between a first position where the opening is closed and a second position where the opening is accessible. The frame preferably includes a lower bar which can be raised and lowered to which the netting is attached. The raising and lowering devices preferably comprise a pair of air cylinders connected to the lower bar.

### CROSS-REFERENCE TO RELATED APPLICATION

The instant application claims the benefit of U.S. Provisional Patent Application Ser. No. 60/314,932, filed Aug. 24, 2001, entitled AUTOMATIC MEZZANINE SAFETY GATE.

### BACKGROUND OF THE INVENTION

The present invention relates to an automatic safety gate for which provides access to a mezzanine or an upper floor while protecting the leading edge of the mezzanine or upper floor.

In the normal course of business, it is necessary for goods to be delivered or retrieved from a mezzanine or an upper floor by a fork lift truck operating on a first floor. To comply with existing OSHA regulations, there must be continuous protection of the leading edge of the mezzanine or upper floor to insure that people do not fall. Any hole or gap in a protective barrier such as a handrail must be constructed so that a person can not get within six feet of the leading edge without some protection against falling.

To date, there is no suitable, commercially available automatic safety gap for closing holes or gaps in a protective barrier and for allowing access to goods stored on an upper floor or mezzanine.

### SUMMARY OF THE INVENTION

Accordingly, it is an object of the present invention to provide an automatic safety gate which covers the gap left in a protective barrier on a mezzanine or an upper floor.

It is a further object of the present invention to provide an automatic safety gate as above which allows a forklift operator access to goods on a mezzanine or an upper floor.

The foregoing objects are attained by the automatic safety gate of the present invention.

In accordance with the present invention, an automatic safety gate broadly comprises a frame defining an opening, a netting attached to the frame, and means for raising and lowering the netting between a first position where the opening is closed and a second position where the opening is accessible to a forklift operator. In a preferred embodiment of the gate of the present invention, the frame includes a lower bar which can be raised and lowered. The netting is attached to the lower bar. The raising and lower means preferably comprises a pair of air cylinders attached to the lower bar.

Other details of the automatic safety gate of the present invention, as well as other objects and advantages attendant thereto, are set forth in the following detailed description and the accompanying drawings in which like reference numerals depict like elements.

### BRIEF DESCRIPTION OF THE DRAWINGS

FIG. 1 is a perspective view of an automatic safety gate in accordance with the present invention; and

FIG. 2 is a perspective view of a lower corner of the automatic safety gate of FIG. 1.

### DETAILED DESCRIPTION OF THE PREFERRED EMBODIMENT(S)

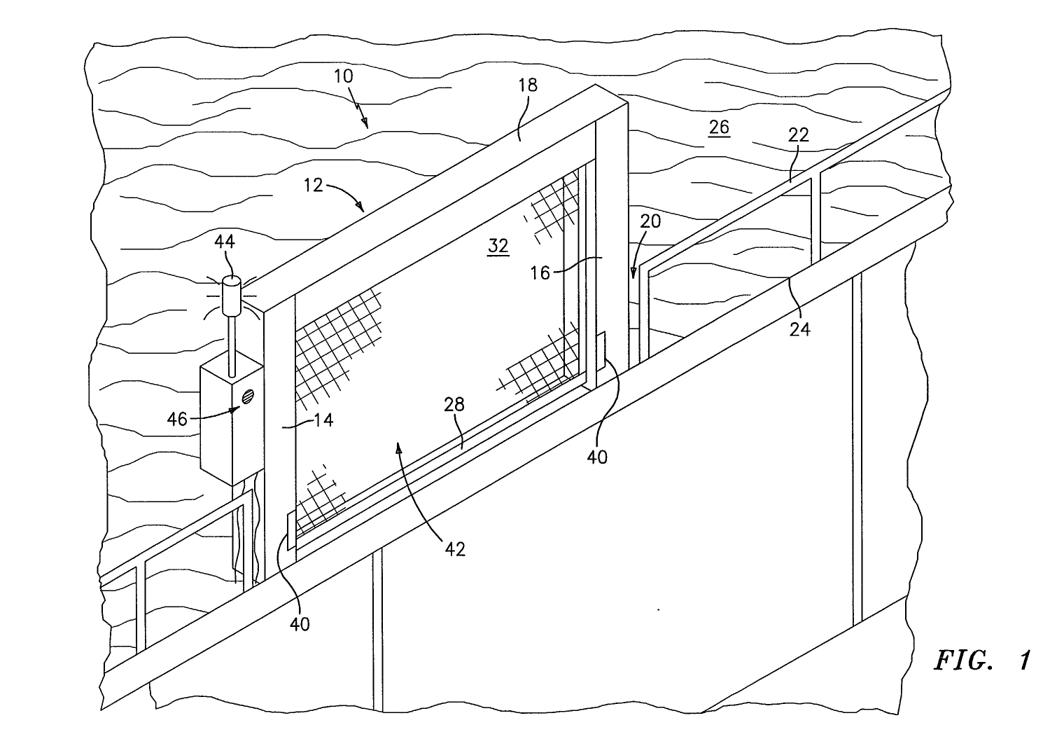

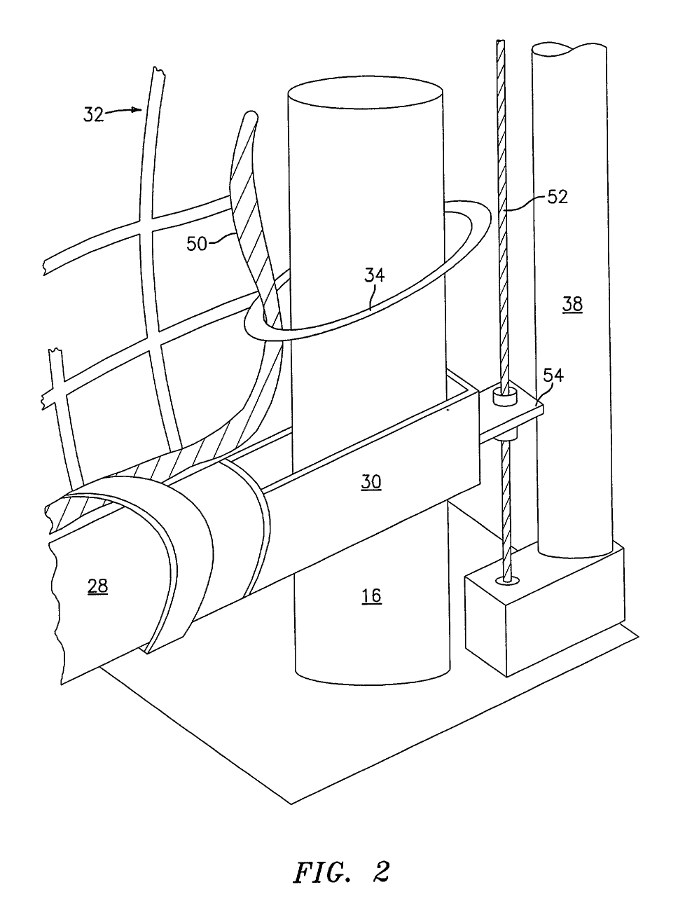

Referring now to FIGS. 1 and 2, an automatic safety gate 10 is provided. The gate 10 has a frame 12, preferably formed from steel, which includes uprights 14 and 16 and cross bar 18. The frame 12 has a width which is substantially equal to the gap 20 in a protective barrier or railing 22 positioned on the leading edge 24 of an upper floor or mezzanine 26.

The frame 12 also includes a lower bar 28 that can be raised and lowered. The lower bar 28 rides on the uprights 14 and 16 by means of a clevis 30 at each of its ends. Each clevis 30 surrounds a respective one of the uprights 14 and 16 and is attached to an end of the lower bar 28 using any suitable means known in the art.

A safety net 32 is provided to close the opening created by the frame 12. The safety net 32 is attached to the cross bar 18 and to the lower bar 28 by means of cable ties. Additionally, the safety net 32 is attached to the uprights 14 and 16 by a plurality of spaced apart steel rings 34 which can move relative to the uprights 14 and 16. As can be seen from FIG. 2, each steel ring 34 overlaps the edge border 50 of the net 32.

The gate 10 further has two air cylinders 38 attached to the lower bar 28 and to the frame 12. Each air cylinder has an internal piston (not shown) to which a continuous cable 52 is attached. The ends of the continuous cable 52 are attached to a plate 54 affixed or integrally joined to the clevis 30. As the piston is caused to moved downwardly in each air cylinder, the lower bar 28 is raised. When the piston in each air cylinder is caused to move upwardly, the lower bar 28 is lowered.

The gate 10 further includes an infrared sensor 40 for detecting the presence of a fork lift. When the infrared sensor 40 detects the presence of the fork lift, the air cylinders 38 are operated to raise the lower bar 28 and thereby the safety net 32 to provide the forklift operator with access to the opening 42 defined by the frame 12 and to the goods stored on the upper floor or mezzanine 26. The air cylinders 38 preferably raise the lower bar 28 completely to the level of the cross bar 18.

A warning light 44 and an audible alarm 46 are provided to provide warnings that the gate 10 is open and that personnel should stay away from the opening 42.

When the forklift has completed its task and is leaving, the infrared sensor 40 detects the movement away and causes the air cylinders 38 to lower the bar 28 and force it into a closed position. Positive air pressure in the air cylinders 38 keeps the safety gate 10 in a locked position, making it extremely difficult for the gate 10 to be operated manually.

One of the advantages to the safety gate 10 of the present invention is that it can not be operated from the mezzanine or upper floor level, thus adding an additional degree of safety.

While it is preferred to provide a pair of air cylinders 38 to raise and lower the lower bar 28, in some situations, only a single air cylinder 38 may be used. Similarly, in other situations, more than two air cylinders 38 may be used to raise and lower the bar 28 if desired.

It is apparent that there has been provided in accordance with the present invention an automatic safety gate which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations which fall within the broad scope of the appended claims.

What is claimed is:

1. An automatic safety gate comprising:
a frame defining an opening;
a netting attached to the frame; and
means for raising and lowering the netting between a first position where the opening is closed and a second position where the opening is accessible to a forklift operator.

2. An automatic safety gate according to claim 1, wherein said frame includes a lower bar which can be raised and lowered and wherein said netting is attached to said lower bar.

3. An automatic safety gate according to claim 2, wherein said raising and lowering means comprises at least one air cylinder attached to the lower bar.

4. An automatic safety gate according to claim 2, wherein said raising and lowering means comprises at least two air cylinders attached to the lower bar.

5. An automatic safety gate according to claim 2, wherein said frame further includes a pair of uprights and a cross bar connecting said uprights.

6. An automatic safety gate according to claim 5, wherein said lower bar has a clevis at each end and each said clevis surrounds a respective one of the uprights.

7. An automatic safety gate according to claim 5, wherein said netting is attached to each of said cross bar and said lower bar by means of cable ties.

8. An automatic safety gate according to claim 5, wherein said netting is attached to said uprights by a plurality of spaced apart rings.

9. An automatic safety gate according to claim 6, wherein said raising and lowering means includes at least one air cylinder attached to said lower bar and a cable attached to each said at least one air cylinder, wherein said lower bar further has a plate attached to each said clevis, and each said cable is attached to a respective one of said plates.

10. An automatic safety gate according to claim 2, wherein said gate is positioned on a raised floor having a protective barrier with an opening and said frame has a width substantially equal to said opening.

11. An automatic safety gate according to claim 1, further comprising means for detecting the presence of a forklift and said raising and lowering means being operated to raise the netting when said forklift presence is detected and to lower the netting when said forklift moves away from said gate.

12. An automatic safety gate according to claim 11, wherein said detecting means comprises an infrared sensor.

13. An automatic safety gate according to claim 1, further comprising means for producing a signal when said netting is in said second position.

14. An automatic safety gate according to claim 13, wherein said signal producing means comprises a warning light.

15. An automatic safety gate according to claim 13, wherein said signal producing means comprises an audible alarm.
